(19) United States
(12) Patent Application Publication
(10) Pub. No.: US 2025/0206289 A1
(43) Pub. Date: Jun. 26, 2025

(54) DISCONNECT CLUTCH CONNECTED DATA STROKE STATE STRATEGY

(71) Applicant: Ford Global Technologies, LLC, Dearborn, MI (US)

(72) Inventors: Brendan Diamond, Grosse Pointe, MI (US); Joseph F. Kucharski, Livonia, MI (US)

(21) Appl. No.: 18/394,654

(22) Filed: Dec. 22, 2023

(51) Int. Cl. B60W 20/40; B60W 10/02; B60W 10/06; B60W 20/15; B60W 40/09; B60W 50/00

(52) U.S. Cl. CPC B60W 20/40; B60W 10/02; B60W 10/06; B60W 20/15; B60W 40/09; B60W 50/00; B60W 2050/0026; B60W 2530/10; B60W 2540/30; B60W 2552/05; B60W 2552/15; B60W 2554/406; B60W 2555/60; B60W 2556/10; B60W 2556/65; B60W 2710/06

(57) ABSTRACT

Methods and systems are provided for adjusting a state of a driveline disconnect clutch (DCC) of a hybrid vehicle to either maximize fuel efficiency or reduce time to engine start, when the hybrid vehicle is being operated under engine-off conditions. In one embodiment, a controller of the vehicle estimates a modified driver demand power at an upcoming location on a route of the vehicle, and adjusts the DCC to a fully depressurized state to maximize the fuel efficiency when the modified driver demand power is lower, and pressurizes the DCC to a touch point to reduce the time to engine start when the modified driver demand power is higher. The modified driver demand power may be estimated by the controller by applying multiplication factors to a vehicle-weight-based baseline driver demand power, where the multiplication factors are calculated based on vehicle density of traffic and route characteristics.

### FIELD

The present description relates to a system and methods for hybrid vehicles, and more particularly, to controlling a state of a driveline disconnect clutch to increase fuel economy or reduce engine start time.

### BACKGROUND AND SUMMARY

A hybrid vehicle (HV) may include a modular hybrid transmission (MHT). Therein, a driveline disconnect clutch positioned between an engine and an electric motor of the HV can mechanically and selectively isolate an internal combustion engine (ICE) from the transmission and vehicle wheels so that the transmission and wheels can operate independently from the engine. The driveline disconnect clutch (DCC) allows torque to be provided to the driveline to propel the vehicle even if the engine has stopped rotating. When the DCC is disengaged, the electric motor and engine can spin independently of each other. When the DCC is engaged, the electric motor may provide all of the propulsion power for the vehicle. In addition, the MHT system may include an electric motor located between the flex-plate and the torque converter and can be used to supplement torque output as well as absorb and store power during vehicle slowing. The MHT system may also include a flywheel, which may store mechanical energy to balance the engine for increased performance.

The MHT powertrain may use engine-based propulsion, electric motor-based propulsion, or both engine-based propulsion and electric motor-based propulsion concurrently (e.g., in parallel) to meet a driver demand for torque or power. When a driver of the hybrid vehicle demands a large amount of torque/power, if the engine is off, the hybrid vehicle may rely on a fast engine start to meet the driver demand for power.

The MHT powertrain may include various mechanisms to start the engine. A first mechanism includes using the DCC to pull the engine up to a desired speed to meet the driver demand for power. The first mechanism relies on the electric motor being active and in an electric propulsion (EV) mode, to turn a main oil pump on the MHT (e.g., turning the impeller) and provide a torque to turn the engine. Alternatively, a 12V flywheel start (FWS) may be performed, where the flywheel is used to turn the engine. In such cases, the DCC connects the engine to the driveline after the engine has started rotating and combustion is sustainable. As a third alternative, a chain-integrated starter generator (ISG) or driveline integrated starter generator (DISG) may be used to pull up the engine, with the DCC connecting the engine to the driveline after the engine has started rotating and combustion is sustainable. The flywheel start and the BISG/DISG start may be used when the DCC cannot be gracefully controlled, for example, due to inadequate line pressure supply, or due to noise, vibration, and harshness (NVH) constraints. The DCC cranking start (e.g., the first mechanism) may be the fastest type of start, and may help meet the driver demand in a shortest amount of time. As a result, the DCC may be used as the preferred starting mechanism for fast starts.

However, the inventors herein have recognized issues with using the DCC to start the engine during a transition from electric power. When an engine start is not expected, the DCC may be placed in an “open” state, where the DCC is fully de-pressurized and plates of the DCC are not touching, to generate a reduced drag (e.g., <1 Nm), which may increase fuel efficiency (FE). However, as a result of the DCC being in the open state, an amount of time between an engine start request and a torque control mode of the engine being achieved (e.g., an actuation lag) may be longer than desired, resulting in decreased performance of the vehicle. The actuation lag may be reduced by placing the DCC in a pre-charged state, meaning, pressurized but not to a touch point (e.g., where plates of the DCC are touching). In the pre-charged state, clutch drag may be higher than when the DCC is in the open state. The actuation lag may be further reduced or eliminated by placing the DCC in a “stroked” state, where the DCC is pressurized to the touch point, further increasing the clutch drag. Thus, a tradeoff may exist between the speed with which the engine may be started and the fuel efficiency; if fuel efficiency is prioritized, the actuation lag may be pronounced, and if the actuation lag is reduced, the fuel efficiency may be reduced.

In one example, the above issue may be at least partly addressed by a method for a controller of a hybrid vehicle, the method comprising, during operation of the hybrid vehicle using an electric motor, an engine of the hybrid vehicle off, estimating a modified driver demand power at a location of the hybrid vehicle; in response to a difference between the modified driver demand power and a pull-up threshold of the engine at the location being less than a first threshold difference, pressurizing a driveline disconnect clutch (DCC) to a touch point of the DCC (e.g., stroking the DCC) to reduce a delay in starting the engine. In response to the difference being between the first threshold difference and a second threshold difference, the second threshold difference greater than the first threshold difference, the method may include setting the DCC to a pre-charged state (e.g., pressurizing the DCC to below the touch point). In response to the difference being greater than the second threshold difference, the method may include setting the DCC to an open state.

The modified driver demand power may be estimated by first estimating a baseline driver demand power at the location based on a weight of the vehicle, and then applying one or more multiplication factors to the baseline driver demand power based on estimated traffic at the location (e.g., vehicle density) and/or characteristics of the location (e.g., stop signs, traffic signals, highway on-ramps, etc.) that are likely to influence the modified driver demand power.

As an example, the vehicle may be operated along a route with minimal traffic. As a result of the minimal traffic, the DCC may be set to an open state, to reduce a clutch drag of the DCC and thereby increase a fuel efficiency of the vehicle. The vehicle may detect congestion at a future location of the vehicle on the route, for example, via a front-end camera of the vehicle, or via vehicle-to-vehicle (V2V) communication with other vehicles included in the congestion. As the vehicle approaches the location of the congestion, the controller may pressurize the DCC to a touch point of the DCC (e.g., stroke the DCC, or place the DCC in a stroked state) in anticipation of a driver demand for power, for example, due to an increase in the rate of change of velocity when navigating traffic. By stroking the DCC, a time taken to meeting the driver demand power using both of the electric motor and the engine may be reduced, and the vehicle may achieve the torque control mode more quickly, resulting in more responsive performance during an increase in the rate of change of velocity. Alternatively, if a probability of the driver demand for power increases, but remains below a threshold probability, the DCC may be placed in a pre-charged state, where the DCC is pressurized to a lesser degree (e.g., not to the touch point). In the pre-charged state, the fuel efficiency of the vehicle may be slightly decreased with respect to the open state, but the time taken for achieving a driver demand power may also be decreased. Thus, the pre-charged state represents an intermediate stage between the open state and the stroked state.

In this way, an actuation delay or lag when the engine is turned on to achieve a driver demand power may be advantageously reduced, by adjusting the state of the DCC in anticipation of the driver demand for power, and a smoother transmission shift may be enabled. The driver demand power may be anticipated based on historical vehicle data and/or crowdsourced data of other vehicles traveling on the route, vehicle weight, traffic conditions, and/or characteristics of the route that may cause the driver to request additional torque. Overall, a performance of the vehicle may be increased during transitions from electric power to engine power, while fuel efficiency of the vehicle may be prioritized when the transitions are not expected.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of an engine;

FIG. 2 shows an example embodiment of a vehicle driveline configuration;

FIG. 3 is a flowchart illustrating an exemplary method for controlling a state of a driveline disconnect clutch of a vehicle, in accordance with one or more embodiments of the present disclosure;

FIG. 4 is a diagram showing changes in a modified driver demand power of a vehicle along a route, in accordance with one or more embodiments of the present disclosure; and

FIG. 5 is a timing diagram illustrating an exemplary sequence of actions/events occurring as a driver demand power of a vehicle changes, in accordance with one or more embodiments of the present disclosure.

### DETAILED DESCRIPTION

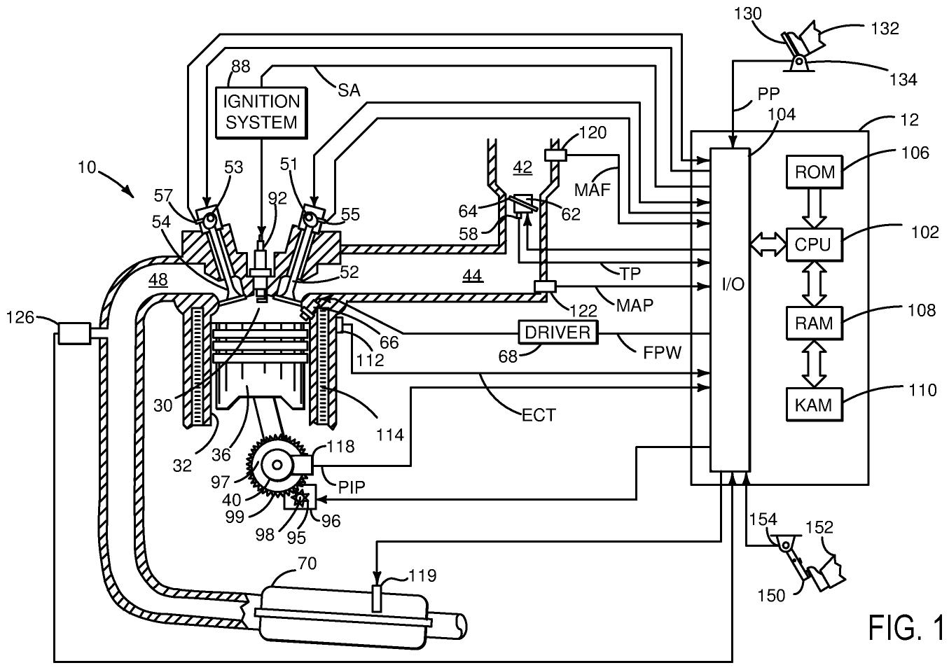

Referring to FIG. 1, an internal combustion engine 10, comprising a plurality of cylinders, one cylinder of which is shown in FIG. 1, is controlled by electronic engine controller 12. Engine 10 includes combustion chamber 30 and cylinder walls 32 with piston 36 positioned therein and connected to crankshaft 40. Flywheel 97 and ring gear 99 are coupled to crankshaft 40. Starter 96 includes pinion shaft 98 and pinion gear 95. Pinion shaft 98 may selectively advance pinion gear 95 to engage ring gear 99. Starter 96 may be directly mounted to the front of the engine or the rear of the engine. In some examples, starter 96 may selectively supply torque to crankshaft 40 via a chain. Starter 96 may be described as a lower power starting device. In one example, starter 96 is in a base state when not engaged to the engine crankshaft. Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. The position of intake cam 51 may be determined by intake cam sensor 55. The position of exhaust cam 53 may be determined by exhaust cam sensor 57.

Fuel injector 66 is shown positioned to inject fuel directly into combustion chamber 30, which is known to those skilled in the art as direct injection. Alternatively, fuel may be injected to an intake port, which is known to those skilled in the art as port injection. Fuel injector 66 delivers liquid fuel in proportion to the pulse width of signal FPW from controller 12. Fuel is delivered to fuel injector 66 by a fuel system (not shown) including a fuel tank, fuel pump, and fuel rail (not shown). Fuel injector 66 is supplied operating current from driver 68 which responds to controller 12. In addition, intake manifold 44 is shown communicating with optional electronic throttle 62 which adjusts a position of throttle plate 64 to control air flow from air intake 42 to intake manifold 44. In one example, a low pressure direct injection system may be used, where fuel pressure can be raised to approximately 20-30 bar. Alternatively, a high pressure, dual stage, fuel system may be used to generate higher fuel pressures. In some examples, throttle 62 and throttle plate 64 may be positioned between intake valve 52 and intake manifold 44 such that throttle 62 is a port throttle.

Distributor less ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of catalytic converter 70. Alternatively, a two-state exhaust gas oxygen sensor may be substituted for UEGO sensor 126.

Converter 70 can include multiple catalyst bricks, in one example. In another example, multiple emission control devices, each with multiple bricks, can be used. Converter 70 can be a three-way type catalyst, a particulate filter, a lean NOx trap, selective reduction catalyst, or other emissions control device. An emissions device heater 119 may also be positioned in the exhaust system to heat converter 70 and/or exhaust gases.

Controller 12 is shown in FIG. 1 as a conventional microcomputer including: microprocessor unit 102, input/output ports 104, read-only memory 106, random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to a pedal 130 for sensing force and/or position applied by foot 132 for controlling vehicle drive torque; a position sensor 154 coupled to pedal 150 for sensing force and/or position applied by foot 152; a measurement of engine manifold pressure (MAP) from pressure sensor 122 coupled to intake manifold 44; an engine position from an engine position sensor 118 such as a Hall effect sensor sensing crankshaft 40 position; a measurement of air mass entering the engine from sensor 120; and a measurement of throttle position from sensor 58. Barometric pressure may also be sensed (sensor not shown) for processing by controller 12. In a preferred aspect of the present description, engine position sensor 118 produces a predetermined number of equally spaced pulses every revolution of the crankshaft from which engine speed (RPM) can be determined.

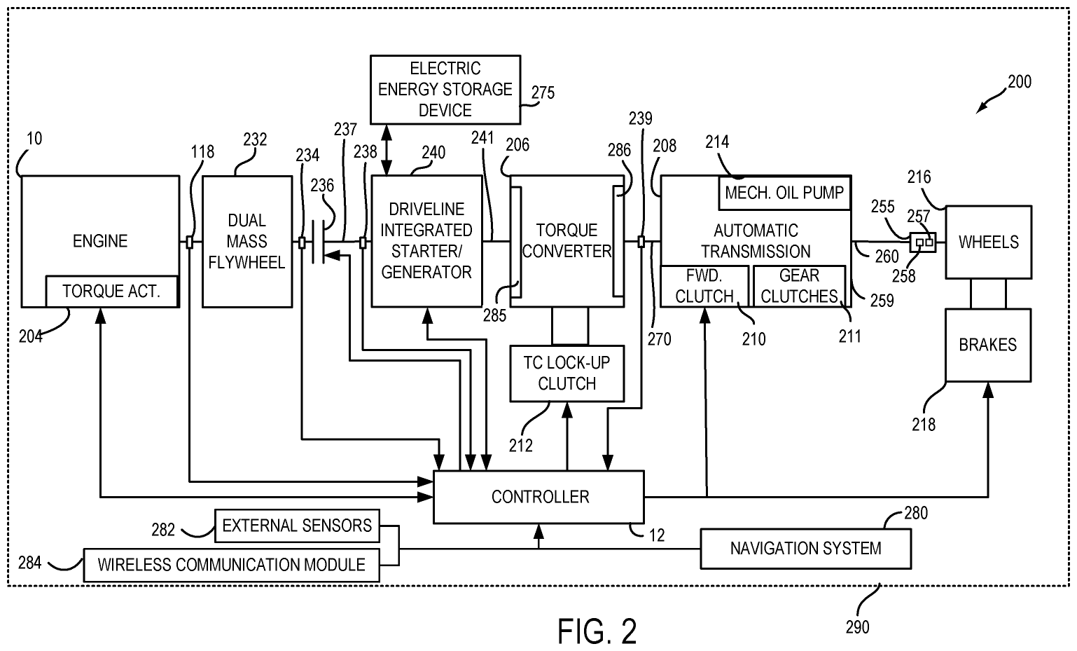

In some examples, the engine may be coupled to an electric motor/battery system in a hybrid vehicle as shown in FIG. 2. Further, in some examples, other engine configurations may be employed, for example a diesel engine.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC). During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion. During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

FIG. 2 is a block diagram of a vehicle driveline 200 in vehicle 290. Driveline 200 may be powered by engine 10. Engine 10 may be started with an engine starting system shown in FIG. 1 or via an electric machine, such as a driveline integrated starter-generator (DISG) 240. In other embodiments, vehicle 290 may include an electric machine that is not integrated into driveline 200, and/or a different engine starting system. For example, vehicle 290 may include a 12V fly wheel starter (FWS), or an integrated starter generator (ISG) that drives a chain to rotate the crankshaft. Further, engine 10 may generate or adjust torque via torque actuator 204, such as a fuel injector, throttle, etc.

An engine output torque may be transmitted to an input side of dual mass flywheel 232. Engine speed as well as dual mass flywheel input side position and speed may be determined via engine position sensor 118. Dual mass flywheel 232 may include springs and separate masses (not shown) for dampening driveline torque disturbances. The output side of dual mass flywheel 232 is shown being mechanically coupled to the input side of driveline disconnect clutch (DCC) 236. DCC 236 may be electrically or hydraulically actuated. A position sensor 234 is positioned on the DCC side of dual mass flywheel 232 to sense the output position and speed of the dual mass flywheel 232. In some examples, position sensor 234 may include a torque sensor. The downstream side of DCC 236 is shown mechanically coupled to DISG input shaft 237.

DISG 240 may be operated to provide torque to driveline 200 or to convert driveline torque into electrical energy to be stored in electrical energy storage device 275. DISG 240 has a power output that is greater than starter 96 shown in FIG. 1. Further, DISG 240 directly drives driveline 200 or is directly driven by driveline 200. There are no straps, gears, or chains to couple DISG 240 to driveline 200. Rather, DISG 240 rotates at the same rate as driveline 200. Electrical energy storage device 275 may be a battery, capacitor, or inductor. The downstream side of DISG 240 is mechanically coupled to the impeller 285 of torque converter 206 via shaft 241. The upstream side of the DISG 240 is mechanically coupled to the DCC 236.

Torque converter 206 includes a turbine 286 to output torque to input shaft 270. Input shaft 270 mechanically couples torque converter 206 to automatic transmission 208. Torque converter 206 also includes a torque converter bypass lock-up clutch 212 (also referred to as torque converter clutch or TCC 212). Torque is directly transferred from impeller 285 to turbine 286 when TCC 212 is locked. TCC 212 is electrically operated by controller 12. Alternatively, TCC 212 may be hydraulically locked. In one example, the torque converter may be referred to as a component of the transmission. Torque converter impeller speed and position may be determined via sensor 238. Torque converter turbine speed and position may be determined via position sensor 239. In some examples, sensors 238 and/or 239 may be torque sensors or may be combination position and torque sensors.

When torque converter clutch 212 is fully disengaged, torque converter 206 transmits engine torque to automatic transmission 208 via fluid transfer between the torque converter turbine 286 and torque converter impeller 285, thereby enabling torque multiplication. In contrast, when torque converter clutch 212 is fully engaged, the engine output torque is directly transferred via the torque converter clutch to an input shaft 270 of transmission 208. Alternatively, the torque converter clutch 212 may be partially engaged, thereby enabling the amount of torque directly relayed to the transmission to be adjusted. The controller 12 may be configured to adjust the amount of torque transmitted by torque converter 206 by adjusting the torque converter clutch 212 in response to various engine operating conditions, or based on a driver-based engine operation request.

Automatic transmission 208 includes gear clutches (e.g., gears 1-6) 211 and forward clutch 210. The gear clutches 211 and the forward clutch 210 may be selectively engaged to propel a vehicle. Torque output from the automatic transmission 208 may in turn be relayed to wheels 216 to propel the vehicle via output shaft 260. Output shaft 260 delivers torque from transmission 208 to wheels 216 via differential 255 which includes first gear 257 and second gear 258. Automatic transmission 208 may transfer an input driving torque at the input shaft 270 responsive to a vehicle traveling condition before transmitting an output driving torque to the wheels 216.

Further, a frictional force may be applied to wheels 216 by engaging wheel friction calipers 218. In one example, wheel friction calipers 218 may be engaged in response to the driver pressing his foot on a left pedal (not shown). In other examples, controller 12 or a controller linked to controller 12 may engage wheel friction calipers. In the same way, a frictional force may be reduced to wheels 216 by disengaging wheel friction calipers 218 in response to the driver releasing his foot from a left pedal. Further, vehicle calipers may apply a frictional force to wheels 216 via controller 12 as part of an automated engine stopping procedure.

A mechanical oil pump 214 may be in fluid communication with automatic transmission 208 to provide hydraulic pressure to engage various clutches, such as forward clutch 210, gear clutches 211, and/or torque converter clutch 212. Mechanical oil pump 214 may be operated in accordance with torque converter 206, and may be driven by the rotation of the engine or DISG via input shaft 241, for example. Thus, the hydraulic pressure generated in mechanical oil pump 214 may increase as an engine speed and/or DISG speed increases, and may decrease as an engine speed and/or DISG speed decreases.

Controller 12 may be configured to receive inputs from engine 10, as shown in more detail in FIG. 1, and accordingly control a torque or power output of the engine and/or operation of the torque converter, transmission, DISG, clutches, and/or calipers. As one example, an engine torque output may be controlled by adjusting a combination of spark timing, fuel pulse width, fuel pulse timing, and/or air charge, by controlling throttle opening and/or valve timing, valve lift and boost for turbo- or super-charged engines. In the case of a diesel engine, controller 12 may control the engine torque output by controlling a combination of fuel pulse width, fuel pulse timing, and air charge. In all cases, engine control may be performed on a cylinder-by-cylinder basis to control the engine torque output. Controller 12 may also control torque output and electrical energy production from DISG by adjusting current flowing to and from DISG windings as is known in the art.

When idle-stop conditions are satisfied, controller 12 may initiate engine shutdown by shutting off fuel and spark to the engine. However, the engine may continue to rotate in some examples. Further, to maintain an amount of torsion in the transmission, the controller 12 may ground rotating elements of transmission 208 to a case 259 of the transmission and thereby to the frame of the vehicle. In particular, the controller 12 may engage one or more transmission clutches, such as forward clutch 210, and lock the engaged transmission clutch(es) to the transmission case 259 and vehicle frame. A transmission clutch pressure may be varied (e.g., increased) to adjust the engagement state of a transmission clutch, and provide a desired amount of transmission torsion.

A wheel caliper pressure may also be adjusted during the engine shutdown, based on the transmission clutch pressure, to assist in tying up the transmission while reducing a torque transferred through the wheels. Specifically, by applying the wheel calipers 218 while locking one or more engaged transmission clutches, opposing forces may be applied on transmission, and consequently on the driveline, thereby maintaining the transmission gears in active engagement, and torsional potential energy in the transmission gear-train, without moving the wheels. In one example, the wheel caliper pressure may be adjusted to coordinate the application of the wheel calipers with the locking of the engaged transmission clutch during the engine shutdown. As such, by adjusting the wheel caliper pressure and the clutch pressure, the amount of torsion retained in the transmission when the engine is shutdown may be adjusted. When restart conditions are satisfied, and/or a vehicle operator wants to launch the vehicle, controller 12 may reactivate the engine by resuming combustion in cylinders.

The systems of FIG. 1-2 may include torque sensors that may be the basis for adjusting driveline operation. Alternatively, the torque converter itself may be used as the torque sensor when the torque converter clutch 212 is fully disengaged. Specifically, the torque output of an open torque converter is a function of the input and output speeds, the impeller and turbine speeds where the impeller in the torque converter input and the turbine the torque converter output. In the operation of FIG. 2, the impeller speed is equal to the measured DISG speed, as the DISG rotor output shaft is the impeller input shaft and the turbine speed is measured and used in the control of the transmission clutch control.

Additionally, given an input and output speed characterization of the open torque converter, the torque output of the open torque converter can be controlled by controlling the torque converter impeller speed as a function of the torque converter turbine speed. The DISG may be operated in speed feedback mode to control torque converter torque. For example, the commanded DISG speed (e.g., same as torque converter impeller speed) is a function of the torque converter turbine speed. The commanded DISG speed may be determined as a function of both the DISG speed and the turbine speed to deliver the desired torque at the torque converter output.

Vehicle 290 may be operated in an electric vehicle (EV) mode, where propulsion of vehicle 290 may be generated by DISG 240, and/or an ICE mode, where propulsion of vehicle 290 may be generated by engine 10 (with or without DISG 240). DISG 240 may be sufficient for meeting a driver demand power or torque when driving at lower speeds with modest increase in the rate of change of velocity, assuming a high enough state of charge (SOC) of electrical energy storage device 275. However, if the driver demand power is above a threshold amount of power used to start engine 10 (also referred to herein as an engine pull-up threshold), controller 12 may switch engine 10 on to generate additional torque/power. For example, engine 10 may be switched on when increasing speed after a stop, such as at a traffic light, or when entering an on-ramp of a highway, or when sudden ss may be made to navigate moderate vehicle traffic. In such situations, it may be desirable to transition to engine power quickly, to meet the driver demand power.

A fastest way to achieve the driver demand power may be to engage DCC 236 to pull up the engine. However, engaging DCC 236 to pull up the engine may result in an actuation lag or delay between a power request and achieving the driver demand power. The actuation lag may decrease a performance of the vehicle during the increase in the rate of change of velocity. The actuation lag may be reduced by pressurizing DCC 236 to or close to the touch point of DCC 236. However, pressurizing DCC 236 to or close to the touch point may increase an amount of clutch drag of DCC 236, which may reduce an overall fuel efficiency of the vehicle.

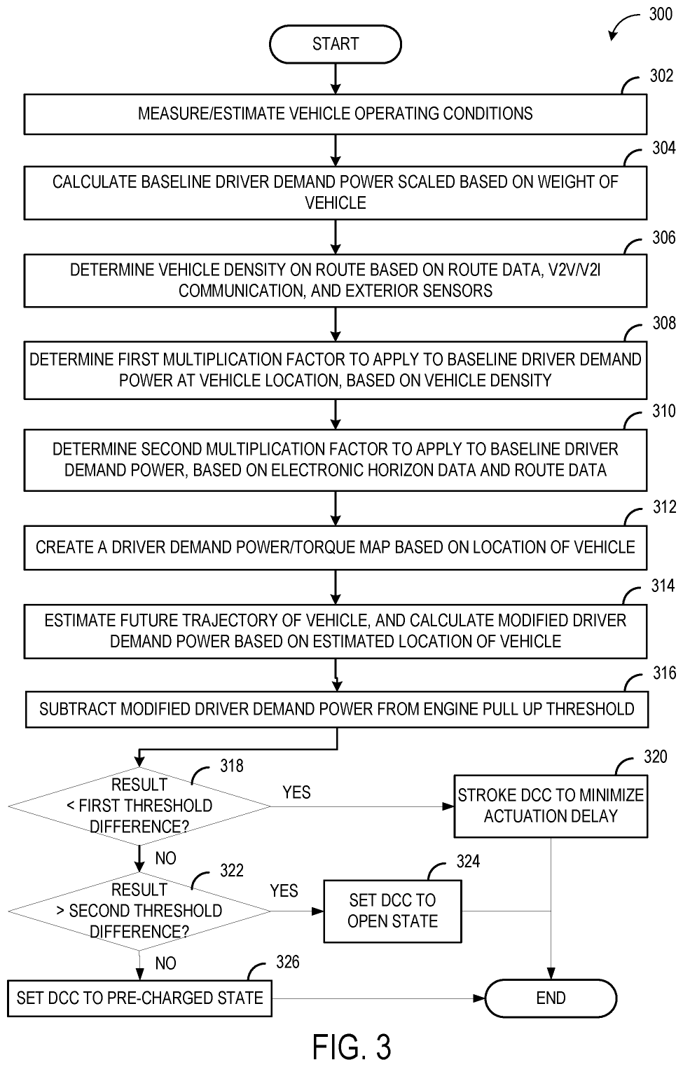

As elaborated with reference to FIG. 3, the tradeoff between fuel efficiency and engine start speed may be advantageously controlled by estimating a modified driver demand power based on a location of the vehicle, and adjusting a state of DCC 236 based on the estimated modified driver demand power. For example, DCC 236 may be adjusted between three states. In a first, open state (e.g., depressurized), the clutch drag of DCC 236 may be reduced, to increase a fuel efficiency of vehicle 290. In a second, pre-charged state, DCC 236 may be partially pressurized in anticipation of a possible driver demand power request, with a modest reduction in fuel efficiency. In a third, stroked state, DCC 236 may be pressurized to the touch point, further sacrificing fuel efficiency to reduce the engine start time and deliver a modified driver demand power within a shortened amount of time, thereby increasing vehicle performance during an increase in the rate of change of velocity. As described below, controller 12 may estimate the modified driver demand power based on a combination of vehicle data, driver data, and route data. In various embodiments, the route data may be provided by a navigation system 280 of vehicle 290, and/or one or more external sensors 282, which may be communicably coupled to controller 12. For example, the one or more external sensors 282 may include a front-end camera, a rear-end camera, side cameras, etc.

Controller 12 may be communicatively coupled to other vehicles or infrastructures via a wireless communication module 284, using appropriate communications technology as is known in the art. For example, controller 12 may be coupled to other vehicles or infrastructures via a wireless network, which may comprise Wi-Fi, Bluetooth, a type of cellular service, a wireless data transfer protocol, and so on. Controller 12 may broadcast (and receive) information regarding vehicle data, traffic conditions, vehicle location information, vehicle operating procedures, etc., via vehicle-to-vehicle (V2V), vehicle-to-infrastructure-to-vehicle (V2I2V), and/or vehicle-to-infrastructure (V2I or V2X) technology. The communication and the information exchanged between vehicles can be either direct between vehicles, or can be multi-hop. In some examples, longer range communications (e.g. WiMax) may be used in place of, or in conjunction with, V2V, or V2I2V, to extend the coverage area by a few miles. In still other examples, controller 12 may be communicatively coupled to other vehicles or infrastructures via the wireless network and the Internet (e.g. cloud), as is commonly known in the art. One example of a V2V communication device may include dedicated-short-range-communication (DSRC) network which may allow vehicles within a threshold proximity (e.g., 5,000 feet) to communicate (e.g., transfer information) free of an internet connection.

Now turning to FIG. 3, an example method 300 is shown for controlling a state of a DCC (e.g., DCC 236) of a hybrid vehicle with an MHT powertrain, such as in the vehicle drivelines of FIGS. 1-2, to either maximize fuel efficiency or facilitate a timely and efficient transition from an EV mode, where propulsion is generated by an electric motor (e.g., DISG 240) of the vehicle, to an ICE mode, where the propulsion is generated by an engine (e.g., engine 10) of the vehicle. The DCC may be controlled by estimating a modified driver demand power at a current or future location of the vehicle based on vehicle data, driver data, and/or route data. The steps of method 300 may be performed by a controller of the vehicle, such as controller 12 of FIGS. 1 and 2.

At 302, method 300 includes estimating and/or measuring vehicle and engine operating conditions. These may include, for example, a current mode of the vehicle (e.g., EV or ICE), a speed of the engine or electric motor, battery state of charge, MAP, BP, engine temperature, ambient conditions including ambient temperature, pressure, and humidity, boost level, EGR rate and amount, etc.

At 304, method 300 includes calculating a baseline driver demand power at a location of the vehicle, scaled as a function of a weight of the vehicle. The location of the vehicle may be a current location of the vehicle along a route of the vehicle, or a predicted future location of the vehicle on the route, as described in greater detail below. The baseline driver demand torque/power may be calculated based on historical data collected from the vehicle while operating on the route. The historical data may include driver profile data stored at the vehicle. That is, calculating the baseline driver demand power may include tracking and monitoring driver demand torque/power requests made by a driver of the vehicle, and storing the driver demand torque/power requests in a memory of the vehicle. The driver demand torque/power requests may be indexed to a location of the vehicle. For example, a first driver demand torque/power request may be made by the driver at a first location, and the first driver demand torque/power request and the first location may be stored in the memory of the vehicle; a second driver demand torque/power request may be made by the driver at a second location, and the second driver demand torque/power request and the second location may be stored in the memory of the vehicle; and so on. In some embodiments, the driver demand torque/power requests and locations may be stored in a server communicatively coupled to the vehicle, for example, via the Internet.

Additionally, driver demand power requests and corresponding locations may be stored for a plurality of drivers of the vehicle, and/or for a plurality of drivers of other vehicles. In other words, a repository of historical driver demand torque/power request data may be collected for the driver, the vehicle, and/or for a plurality of vehicles. Additionally or alternatively, the baseline driver demand torque/power may be calculated based at least partly on crowdsourced data collected from other vehicles being driven on the same route as the vehicle at the same time.

The baseline driver demand power may be based on driver demand power data collected and stored in the repository of historical driver demand power request data. For example, the baseline driver demand power may be an average driver demand power of the driver at the location, or the baseline driver demand power may be an average driver demand power of various drivers of various vehicles at the location. The baseline driver demand power may be based on or expressed as a function of a weight of the vehicle. For example, the baseline driver demand power may be an average power request of vehicles of a same approximate weight or weight class of the vehicle, at the location.

The baseline driver demand power may be different at different locations. For example, the baseline driver demand power for a given location may be retrieved from a lookup table stored in the memory of the vehicle. In other words, historical driver data may be used to generate baseline data for a plurality of vehicles, and baseline driver demand power values may be stored at each vehicle of the plurality of vehicles for a plurality of locations.

In some embodiments, basic filtering may be performed on the historical and/or crowdsourced data. In one example, a weighted time average of the baseline driver demand power may be calculated. That is, the baseline driver demand power may be biased based on a time of a day or time of a week based on an average amount of traffic at the time. In some examples, outliers (e.g., +−2.5 standard deviations) may be eliminated from the data, to reduce a contribution of very aggressive or very slow driver data.

At 306, method 300 includes determining a vehicle density of traffic at the location. The vehicle density may be determined in a combination of various ways. In some embodiments, route data may be retrieved from the vehicle, for example, from a navigation system (e.g., navigation system 280) of the vehicle, and the route data may be used to retrieve traffic data of the route, from which an expected vehicle density at the location may be inferred. The expected vehicle density may be adjusted based on V2V data received from other vehicles operating within a threshold vicinity of the vehicle. V2I data may also be used, for example, from traffic lights, toll booths, or other roadside infrastructure. Additionally or alternatively, exterior sensor data of the vehicle may be used to determine a number of vehicles in an immediate surrounding of the vehicle. For example, front, rear, and/or side cameras of the vehicle may be used to detect nearby vehicles.

At 308, method 300 includes determining a first multiplication factor to be applied to the baseline driver demand power at the location of the vehicle, based on the vehicle density. The first multiplication factor may be calculated based on average vehicle speed of traffic at the location of the vehicle, relative to a speed limit of the route. For example, if the traffic is bumper-to-bumper traffic, the first multiplication factor may be small due to a “low start urgency likelihood”, as driver demand may be presumed to be low. Under such conditions, the DCC should not be stroked, unless a battery of the vehicle (e.g., electrical energy storage device 275 of FIG. 2) has a low state of charge. If there is no traffic and the average vehicle speed is higher than the speed limit, the first multiplication factor for the driver demand may be higher (e.g., 1.0 or higher) due to free-flowing traffic conditions. The free-flowing traffic conditions may indicate a low start urgency likelihood, since the driver may be under little pressure to increase in speed rapidly. In some cases, a driving style of the driver may be considered in setting the multiplication factor. For example, if a driving style associated with a driver profile of the vehicle indicates a tendency to aggressive driving, the first multiplication factor may be increased. Additionally or alternatively, the first multiplication factor may be based on historical driving data, such as, for example, where engine starts have historically occurred at the location of the vehicle.

Free-flowing traffic conditions at a predetermined vehicle density or within a predetermined speed range of the vehicle may indicate a “high start urgency likelihood”, where the driver may have a number of opportunities to want or have to negotiate traffic quickly. In such cases, the first multiplication factor for the driver demand may be higher (e.g., 1.25 or higher). Further, an additional factor used to adjust the first multiplication factor may be a distance or velocity difference between the vehicle and a lead vehicle in the free-flowing traffic. For example, the first multiplication factor may be increased if an engine pull is expected based on an ability or inability of the vehicle to increase in speed, based on other vehicles being in a path of the vehicle.

In some embodiments, the first multiplication factor may be calculated by a rules-based system stored in the memory of the vehicle. The rules-based system may be the same for various vehicles, or specific to a vehicle. The rules-based system may be developed online, and may be periodically retrained or fine-tuned based on driver/vehicle data, or the rules-based system may be developed offline, based on the historical driver demand data collected from the plurality of vehicles. In other embodiments, an artificial intelligence (AI) model, such as a machine learning (ML) model may be used to estimate the first multiplication factor. In some embodiments, software encompassing the rules-based system and/or the ML model may be configured to calculate the first multiplication factor based on real-time observation of driving behaviors. Additionally or alternatively, observations of driving behaviors may be stored and changes may be deployed to the software for planned future use, for example, based upon statistical relevance/confidence. Further, an algorithm of the software may be AI-based, where decision-making processes have degrees of freedom.

At 310, method 300 includes determining a second multiplication factor to apply to the baseline driver demand power at the location, based on electronic horizon data and route data. The second multiplication factor may be an event-based factor, which may be applied to the modified driver demand power based on an event that may occur at the location of the vehicle. For example, the electric horizon data may include a traffic light or a stop sign on the route of the vehicle, where, in a first event, the driver may slow down, and in a second event the driver may speed up. As the vehicle approaches the traffic light or stop sign, the second multiplication factor may be low (e.g., 0.0 to 0.25), as the vehicle is slowing down and expected to stop. In some cases, the second multiplication factor may be a negative number, which may further discourage an engine start when approaching the traffic light or stop sign. As the vehicle leaves the location of the traffic light or stop sign, the second multiplication factor may be higher (e.g., 0.5 to 1.5), as a higher driver demand power request is expected as the vehicle rate of velocity change increases. The second multiplication factor may depend on a speed limit in an area of the traffic light or stop sign, whereas the speed limit increases, the second multiplication factor may increase, and as the speed limit decreases, the second multiplication factor may decrease. Similarly, an on-ramp may cause an increase in the rate of change of velocity event that generates a higher second multiplication factor, as the vehicle is expected to ramp up in speed as moving into faster-moving traffic. In other words, different second multiplication factors may be applied depending on the different locations the vehicle passes through along the route, based on characteristics or features of the route present at each location. The characteristics or features may include stop lights, stop signs, intersections, on-ramps, sharp curves, hills, or a different characteristic that may result in a change in modified driver demand power. In various embodiments, the second multiplication factors may be calibrated during vehicle development, and may stay fixed during a lifetime of the vehicle. For example, the second multiplication factors may be stored in a lookup table in a memory of the vehicle, such as read-only memory 106 of FIG. 1, and retrieved based on a current location of the vehicle as the vehicle is being operated along the route.

At 312, method 300 includes creating a driver demand torque/power map that indicates a modified driver demand power as a function of the location of the vehicle, using the various data described above. The driver demand torque/power map may provide a modified driver demand power at a given location of the vehicle, and may take into consideration vehicle and driver data, traffic data, and route characteristics. For example, in one embodiment, the modified driver demand power may be equal to the baseline (e.g., historical and/or crowdsourced) driver demand power at the location, times the first (e.g., traffic-based) multiplication factor, times the second (e.g., event-based) multiplication factor.

At 314, method 300 includes estimating a future trajectory of the vehicle, and calculating the modified driver demand power at the location of the vehicle based on the future trajectory (e.g., based on the modified driver demand power at upcoming locations within a time horizon). In other words, while the engine is off, the future trajectory of the vehicle may be estimated from data retrieved from the navigation system of the vehicle and the current location of the vehicle. The modified driver demand power may then be estimated for one or more upcoming locations along the estimated future trajectory, using the power/torque demand map or function.

At 316, method 300 includes subtracting the modified driver demand power from an engine pull-up threshold. A difference between the modified driver demand power and the engine pull-up threshold, if low or negative (e.g., if the modified driver demand power is higher than the engine pull-up threshold), may indicate a high probability that a torque/power request may occur (e.g., that the engine is likely to be pulled up).

At 318, method 300 includes determining whether the difference between the modified driver demand power and the engine pull-up threshold is less than a first threshold difference. The first threshold difference may be a percentage of the engine pull-up threshold, such as 5% of the engine pull-up threshold. Alternatively, the engine-pull-up threshold may be a magnitude of a difference in power between the engine and the modified driver demand power. If the difference between the modified driver demand power and the engine pull-up threshold is less than the first threshold difference, it may be inferred that the DCC may be used to increase a speed with which the engine may be started to meet the driver demand power, and method 300 may proceed to 320. At 320, method 300 includes stroking the DCC to reduce an actuation delay during a transition from electric power to engine power, and method 300 ends. By stroking the DCC, a fuel efficiency of the vehicle may be temporarily sacrificed (e.g., decreased) to decrease an amount of time taken by the engine to generate sufficient torque to achieve an actual driver demand torque under applicable road and traffic conditions. Once the DCC is engaged, the DCC may be used to transfer and combine torque generated by the engine with torque generated by the electric motor.

If at 318 it is determined that the difference between the modified driver demand power and the engine pull-up threshold is not less than the first threshold difference, method 300 proceeds to 322. At 322, method 300 includes determining whether the difference between the modified driver demand power and the engine pull-up threshold is greater than a second threshold difference, where the second threshold difference is greater than the first threshold difference. The second threshold difference may be pre-calibrated at a time of manufacturing of the vehicle, and may be defined as a difference in power (measured in kW), or defined as a percentage of the engine pull up threshold. For example, the second threshold difference may be a difference of 5 kW, or 20% of the engine pull up threshold.

If at 322 it is determined that the difference between the modified driver demand power and the engine pull-up threshold is greater than the second threshold difference, method 300 proceeds to 324. At 324, method 300 includes setting the DCC to an open state, and method 300 ends. In other words, a large difference between the modified driver demand power and the engine pull-up threshold may indicate that an increase in driver demand power is unlikely at the time and at the location of the vehicle, and therefore, the DCC may be set to the open state to reduce clutch drag and thereby increase fuel efficiency.

Alternatively, if at 322 it is determined that the difference between the modified driver demand power and the engine pull-up threshold is not greater than the second threshold difference (e.g., the difference is between the first threshold difference and the second threshold difference), method 300 proceeds to 326. At 326, method 300 includes setting the DCC to a pre-charged state, and method 300 ends. Thus, when the difference is neither too low to infer that a change in driver demand power may be about to occur, nor two high to infer that the change in driver demand power is unlikely, the DCC may be set to the pre-charged state to set the clutch drag to balance increased fuel efficiency against a probability that a change in driver demand power may occur in the near future.

It should be appreciated that in various embodiments, method 300 may be performed in a repeated or iterative manner as the driver operates the vehicle.

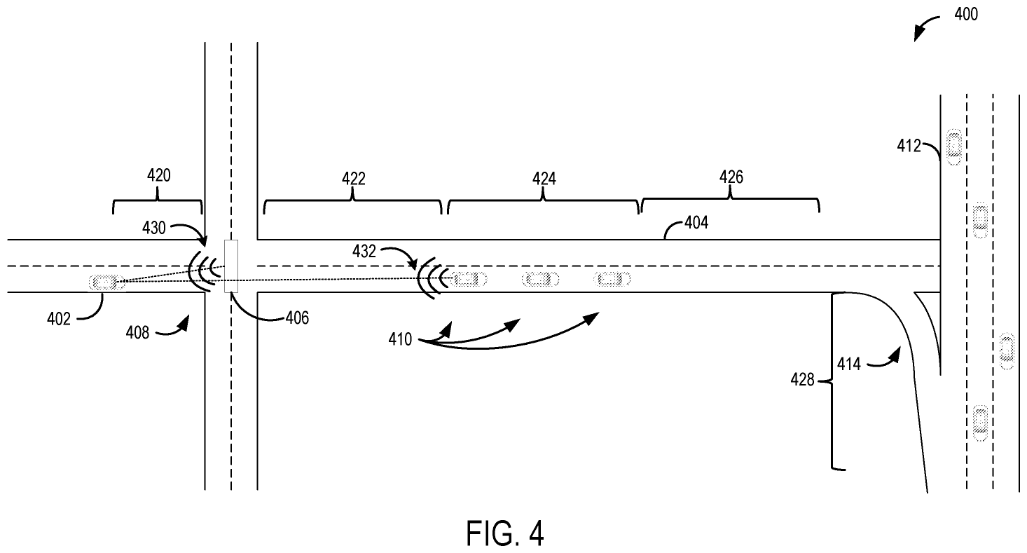

FIG. 4 shows an exemplary driving scenario 400 on which a vehicle 402 may be travelling along a route 404, where an expected driver demand for torque/power may be different at different portions of route 404. Vehicle 402 may be a non-limiting example of vehicle 290 of FIG. 2. Vehicle 402 may be operating under low traffic conditions, and a controller of vehicle 402 may set a DCC (e.g., DCC 236) of vehicle 402 to an open state, to reduce clutch drag and maximize fuel efficiency.

Vehicle 402 is depicted as approaching an intersection 408 including a traffic light 406. The controller of vehicle 402 may receive V2I communications 430 from traffic light 406 indicating a distance of vehicle 402 from traffic light 406. In response to detecting traffic light 406, the controller may estimate a first modified driver demand power to increase, when vehicle 402 passes through intersection 408 and speeds up. As a result, during a first portion 420 of route 404, the controller may adjust the DCC to a stroked state, which may reduce a time taken by an engine of vehicle 402 to achieve the first modified driver demand power.

During a second portion 422 of route 404, the controller may not detect congestion or route characteristics that would suggest an increased modified driver demand power. Consequently, the controller may adjust the DCC to the open state, to increase fuel efficiency. However, the controller may be notified of increased traffic (e.g., a higher vehicle density) in a third portion 424 of route 404 via V2V communication 432 from one or more vehicles 410 proceeding along route 404 ahead of vehicle 402. As a result of being notified of the higher vehicle density, the controller may infer that vehicle 402 may have to increase in speed in order to navigate the increased traffic, and may adjust the DCC to a pre-charged state in anticipation of an increased modified driver demand power.

As vehicle 402 enters the increased traffic, via a front-end camera of vehicle 402, the controller may detect a vehicle 410 in a path of vehicle 402 that is moving at a slower speed than vehicle 402. As a result, the controller may anticipate that vehicle 402 may pass the vehicle 410, and may further adjust the DCC to the stroked state to reduce a start time of the engine as the engine is switched on to meet the increased modified driver demand power.

Vehicle 402 may pass through the increased traffic of third portion 424, and enter a fourth portion 426 of route 404 with less traffic. The controller may determine that a modified driver demand power may be decreased, as a result of there being less traffic in fourth portion 426. However, the controller may detect from navigation system data of vehicle 402 that vehicle 402 is approaching a highway 412, and that the navigation system data indicates that vehicle 402 will turn onto the highway at an on-ramp 414. As a result, during a fifth portion 428 of route 404, the controller may infer that vehicle 402 may receive an increased modified driver demand power as the vehicle increases in speed onto highway 412 via on-ramp 414, and may adjust the DCC to the stroked state to reduce the engine start time.

In this way, the controller may selectively adjust the DCC state for different portions of a route, based on a modified driver demand power that may be different for each portion of the different portions. For portions where an increased driver demand power is expected, the DCC may be pressurized to reduce the engine start time, while for portions where a decreased driver demand power is expected, the DCC may be adjusted to the open state to reduce clutch drag and maximize fuel efficiency.

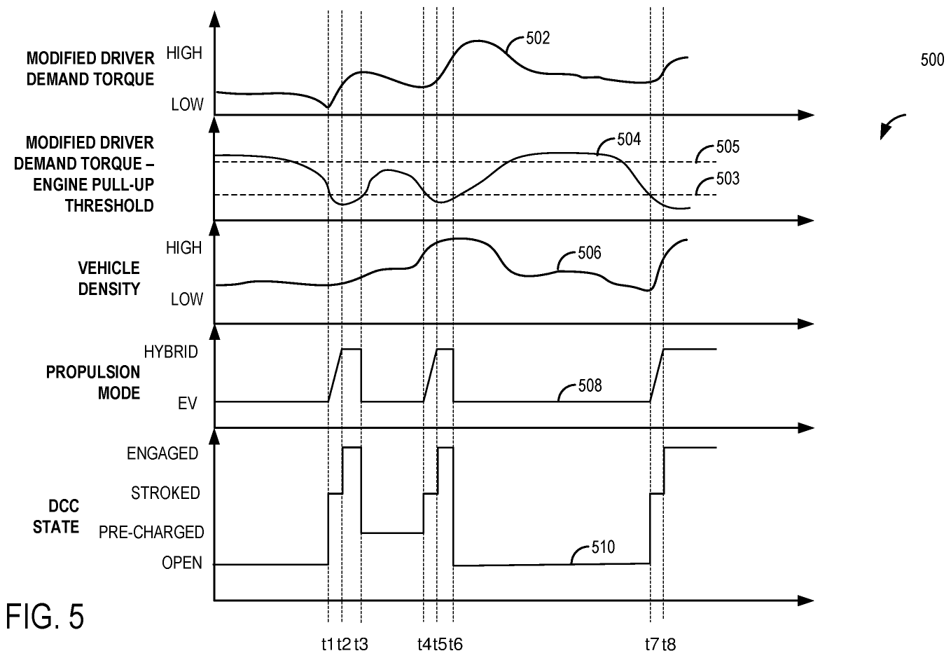

Referring now to FIG. 5, a timing diagram 500 shows an exemplary timing of the sequence of events described above in reference to FIG. 4, as vehicle 402 travels along route 404. A horizontal (x-axis) of timing diagram 500 denotes time, and vertical markers t1-t8 identify significant times at which the events occur. Timing diagram 500 includes five plots. A first plot, line 502, shows a variance in modified driver demand power over time. A second plot, line 504, shows difference between the modified driver demand power of line 502 and a pull-up threshold of an engine of vehicle 402. A first dashed line 503 indicates a first threshold difference and a second dashed line 505 indicates a second threshold difference, where the controller may adjust a state of a DCC of vehicle 402 based on the first threshold difference and the second threshold difference, as described above. A third plot, line 506, shows a vehicle density of traffic along route 404, as detected by V2V/V2I communication (e.g., via wireless communication module 284 of FIG. 2) and/or external sensors (e.g., external sensors 282). A fourth plot, line 508, shows a propulsion mode of vehicle 402, where the propulsion mode may be EV or HYBRID, where HYBRID indicates propulsion based on a combination of an electric motor of the vehicle and the engine. A fifth plot, line 510, shows a state of the DCC of vehicle 402, where the state may be OPEN, PRE-CHARGED, STROKED, or ENGAGED.

Prior to time t1, vehicle 402 is being operated on first portion 420 of route 404. The modified driver demand power is low and close to a baseline driver demand power, as a result of a low first multiplication factor due to low vehicle density, and a low second multiplication factor due to an absence of route characteristics that would suggest an increased driver demand for power.

However, at time t1, the controller determines that vehicle 402 is approaching traffic light 406, as a result of the V2I communication and/or external sensor (e.g., camera) data. The controller may retrieve an increased second multiplication factor from a lookup table in a memory of vehicle 402, based on an assumption that vehicle 402 will request power to increase vehicle speed after stopping at intersection 408. The modified driver demand power increases, due to the increase in the second multiplication factor. As the modified driver demand power increases, the difference between the modified driver demand power and the engine pull-up threshold decreases below the first threshold difference indicated by dashed line 503, which causes the controller to adjust the DCC to the stroked state, in anticipation of the power request associated with the increase in the rate of change of velocity.

At time t2, the DCC is ENGAGED, as a result of the modified driver demand power request (e.g., via an pedal of vehicle 402). Vehicle 402 moves away from traffic light 406 under ICE power at increasing speed between time t2 and time t3.

At time t3, vehicle 402 is operating on second portion 422 of route 404. Due to an absence of traffic and an absence of route characteristics that would suggest an increased driver demand for power, the first and second multiplication factors are low, and the modified driver demand power decreases, and vehicle 402 switches back to EV mode. However, because the V2V communication indicates increased traffic on third portion 424, an increased first multiplication factor is retrieved from the memory of the vehicle, which maintains the difference between the modified driver demand power and the engine pull-up threshold above the first threshold difference, but below the second threshold difference. As a result, the DCC is adjusted to the PRE-CHARGED state.

At time t4, vehicle 402 enters the increased traffic in third portion 424 of route 404. For example, the controller may detect the vehicles 410 via a front-end camera of vehicle 402. Due to a proximity of the vehicles 410 to vehicle 402, the controller may calculate an increased first multiplication factor, which increases the modified driver demand power. As a result, the controller actuates the DCC to the STROKED state.

At time t5, the DCC is ENGAGED, as a result of a modified driver demand power request to pass around vehicles 410. Vehicle 402 increases velocity into fourth portion 426 of route 404 between time t5 and time t6.

At time t6, vehicle 402 is in fourth portion 426, where as a result of easier driving conditions at a steady, moderate velocity, the modified driver demand power decreases (e.g., as a result of low first and second multiplication factors). Vehicle 402 switches back to EV mode, and the controller actuates the DCC to the OPEN state to maximize fuel efficiency.

At time t7, vehicle 402 determines that route 404 takes vehicle 402 onto highway 412, for example, from navigation system data of vehicle 402. Additionally, on-ramp 414 may be detected by a sensor of vehicle 402, such as the front-end camera. Additionally, the controller may detect vehicle traffic on highway 412 from V2V communication. The controller may retrieve from the memory an increased first multiplication factor due to the vehicle traffic and an increased second multiplication factor due to route 404 including on-ramp 414, which may cause the modified driver demand power to increase. The difference between the modified driver demand power and the engine pull-up threshold decreases below the first threshold difference, and the controller actuates the DCC to the STROKED state, in anticipation of an engine start to achieve the increased modified driver demand power. At time t8, the DCC is ENGAGED, and vehicle 402 is maintained in the ICE propulsion mode (e.g., to maintain a higher, highway velocity.

Thus, methods and systems are provided for selectively adjusting a state of a DCC of a hybrid vehicle to either maximize fuel efficiency, or reduce a time to engine start when the hybrid vehicle is being operated under engine-off conditions. To determine how to selectively adjust the state of the DCC, a controller of the vehicle estimates a modified driver demand power at an upcoming location on a route of the vehicle. The modified driver demand power may be estimated by the controller by applying multiplication factors to a vehicle-weight-based baseline driver demand power, which may be calculated based on driving (e.g., power request) data collected from a plurality of drivers of a plurality of vehicles operating on the route (e.g., historical driving data and/or crowdsourced driving data). A first multiplication factor may be calculated based on vehicle density of traffic, where the vehicle density may be an indicator of an increased driver demand for power. The vehicle density may be estimated based on V2V communication with other vehicles, V2I communication with elements of infrastructure on the route, and/or external sensors of the vehicle. A second multiplication factor may be calculated based on events that may generate an increased demand for power as a result of characteristics of the route, such as traffic lights, stop signs, highway on-ramps, hills, curves, etc. The route characteristics may be determined, for example, from navigation system data of the vehicle or external sensors of the vehicle. The estimated modified driver demand power may be used to gauge a potential power request at the upcoming location. Specifically, the estimated modified driver demand power may be compared with an engine pull-up threshold. If a difference between the estimated modified driver demand power and the engine pull-up threshold is lower than a first threshold, the controller may pressurize the DCC to a touch point (e.g., stroke the DCC) to reduce the time to engine start, thereby increasing a performance of the vehicle. Alternatively, if the difference between the estimated modified driver demand power and the engine pull-up threshold is higher than a second threshold, the controller may depressurize the DCC to reduce clutch drag and increase an overall fuel efficiency of the vehicle. If the difference is between the first and second thresholds, the DCC may be partly pressurized (e.g., not quite to the touch point), in anticipation of a possible but less likely request for power, to balance the fuel efficiency against the reduced time to engine start.

In this way, an actuation lag between a time when increased power is requested by a driver of the vehicle when the engine is off and the fulfillment of the power request by the engine may be reduced, resulting in faster increase in the rate of change of velocity during a transition from EV propulsion to HYBRID propulsion. When the transition may not be likely, fuel efficiency may be prioritized. The technical effect of adjusting the state of the DCC based on the estimated modified driver demand power is that a tradeoff between fuel efficiency and faster increase in the rate of change of velocity during EV to HYBRID mode transitions may be managed to increase overall vehicle performance.

The disclosure also provides support for a method for a controller of a hybrid vehicle, the method comprising: during operation of the hybrid vehicle using an electric motor, an engine of the hybrid vehicle off: estimating a modified driver demand power at a location of the hybrid vehicle, in response to a difference between the modified driver demand power and a pull-up threshold of the engine at the location being less than a first threshold difference, pressurizing a driveline disconnect clutch (DCC) to a touch point of the DCC to reduce a delay in starting the engine. In a first example of the method, the method further comprises: in response to the difference being greater than a second threshold difference, the second threshold difference greater than the first threshold difference, setting the DCC to an open state to reduce clutch drag and increase fuel efficiency. In a second example of the method, optionally including the first example, the method further comprises: in response to the difference being greater than the first threshold difference and less than the second threshold difference, pressurizing the DCC to less than the touch point. In a third example of the method, optionally including one or both of the first and second examples, estimating the modified driver demand power at the location further comprises calculating a baseline driver demand power of the hybrid vehicle as a function of vehicle weight, based on at least one of: historical driving data of the hybrid vehicle, a driving profile of a driver of the hybrid vehicle, and a time of day at which the hybrid vehicle is being operated. In a fourth example of the method, optionally including one or more or each of the first through third examples, the method further comprises: calculating the baseline driver demand power of a vehicle as a function of vehicle weight based on at least one of: historical data of other vehicles, and crowdsourced data of other vehicles currently being operated along a route of the vehicle. In a fifth example of the method, optionally including one or more or each of the first through fourth examples, estimating the modified driver demand power at the location further comprises calculating a first multiplication factor to apply to the baseline driver demand power at the location, based on a vehicle density of traffic at the location on the route, the vehicle density calculated based on at least one of: a vehicle-to-vehicle (V2V) communication with a different vehicle on a route of the vehicle, a vehicle-to-infrastructure (V2I) communication with an element of infrastructure located along the route, and an exterior sensor of the vehicle. In a sixth example of the method, optionally including one or more or each of the first through fifth examples, estimating the modified driver demand power at the location further comprises determining a second multiplication factor to apply to the baseline driver demand power at the location, based on electronic horizon data and route data. In a seventh example of the method, optionally including one or more or each of the first through sixth examples, determining the second multiplication factor based on the electronic horizon data and the route data further comprises: identifying a characteristic or feature of the route that is likely to cause an increase or decrease in the baseline driver demand power at the location, and retrieving the second multiplication factor from a lookup table stored in a memory of the vehicle based on the identified characteristic or feature. In a eighth example of the method, optionally including one or more or each of the first through seventh examples, the identified characteristic or feature is one of: a traffic light, a stop sign, an on-ramp to a highway, and a hill. In a ninth example of the method, optionally including one or more or each of the first through eighth examples, estimating the modified driver demand power at the location further comprises creating a driver demand torque/power map based on the baseline driver demand power, the first multiplication factor, and the second multiplication factor, and estimating the modified driver demand power based on the driver demand torque/power map.

The disclosure also provides support for a system of a hybrid vehicle, comprising: a modular hybrid transmission (MHT) including a disconnect clutch (DCC) that connects an electric machine and an engine of the hybrid vehicle to a driveline of the hybrid vehicle, a controller, and instructions stored in a memory of the hybrid vehicle that when executed, cause the controller to: when operating the hybrid vehicle with the engine off, estimate a modified driver demand power at a location on a route of the hybrid vehicle, and prior to reaching the location, adjust the DCC to either maximize a fuel efficiency of the hybrid vehicle or reduce a delay in achieving the modified driver demand power using the engine, based on the modified driver demand power. In a first example of the system, further instructions are stored in the memory that when executed, cause the controller to: calculate a difference between the modified driver demand power and an engine pull-up threshold of the hybrid vehicle, in response to the difference being less than a first threshold difference, pressurize the DCC to a touch point of the DCC to reduce the delay in achieving the modified driver demand power, in response to the difference being greater than a second threshold difference, adjust the DCC to an open, fully-depressurized state to maximize the fuel efficiency of the hybrid vehicle, and in response to the difference being between the first threshold difference and the second threshold difference, pressurize the DCC to less than the touch point. In a second example of the system, optionally including the first example, further instructions are stored in the memory that when executed, cause the controller to estimate the modified driver demand power at the location by applying one or more multiplication factors to a baseline driver demand power, the baseline driver demand power calculated based on a weight of the hybrid vehicle and historical vehicle driving data. In a third example of the system, optionally including one or both of the first and second examples, the baseline driver demand power is calculated based partly on data of a plurality of vehicles, the data of the plurality of vehicles including historical driving data of the plurality of vehicles and crowdsourced data of vehicles currently operating on the route. In a fourth example of the system, optionally including one or more or each of the first through third examples, the one or more multiplication factors include a first multiplication factor based on a vehicle density of traffic on the route, the vehicle density estimated using at least one of vehicle-to-vehicle (V2V) communication, vehicle-to-infrastructure (V2I) communication, and an exterior sensor of the hybrid vehicle. In a fifth example of the system, optionally including one or more or each of the first through fourth examples, the one or more multiplication factors include a second multiplication factor based on a characteristic or feature of the route at the location that is likely to cause an increase or decrease in the baseline driver demand power, the second multiplication factor retrieved from a lookup table of the hybrid vehicle.

The disclosure also provides support for a method, comprising: collecting driver demand power request data of one or more drivers of one or more hybrid vehicles during operation of the one or more hybrid vehicles on a route under engine-off conditions, the driver demand power request data including: a location of a hybrid vehicle on the route, a weight of the hybrid vehicle, a feature or characteristic of the route at the location, and a vehicle density of traffic at the location, processing the collected driver demand power request data to generate: a baseline driver demand power scaled by vehicle weight at a plurality of locations of the route, a first set of multiplication factors to be selectively applied to the baseline driver demand power, based on the vehicle density, a second set of multiplication factors to be selectively applied to the baseline driver demand power, based on features or characteristics of the route at a given location of the route, and storing in a memory of each hybrid vehicle of the one or more hybrid vehicles, a baseline driver demand power for the vehicle, the first set of multiplication factors, and the second set of multiplication factors, and instructions that when executed by a controller of the vehicle, cause the controller to: when operating the hybrid vehicle with the engine off, estimate a modified driver demand power at a location on the route based on the stored baseline driver demand power, the stored first set of multiplication factors, and the stored second set of multiplication factors, and in response to a difference between the modified driver demand power and a pull-up threshold of an engine of the hybrid vehicle at the location being less than a first threshold difference, pressurize a driveline disconnect clutch (DCC) of the to a touch point of the DCC to reduce a delay in starting the engine, prior to reaching the location. In a first example of the method, the method further comprises: in response to the difference being greater than a second threshold difference, setting the DCC to an unpressurized state to reduce clutch drag of the DCC, in response to the difference being between the first threshold difference and the second threshold difference, pressurizing the DCC to less than the touch point. In a second example of the method, optionally including the first example, the vehicle density of traffic at the location is determined using one or more of vehicle-to-vehicle (V2V) communication, vehicle-to-infrastructure (V2I) communication, and an exterior sensor of the hybrid vehicle. In a third example of the method, optionally including one or both of the first and second examples, the feature or characteristic of the route at the location is determined from navigation system data of the hybrid vehicle.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for a controller of a hybrid vehicle, the method comprising:
during operation of the hybrid vehicle using an electric motor, an engine of the hybrid vehicle off:
estimating a modified driver demand power at a location of the hybrid vehicle;
in response to a difference between the modified driver demand power and a pull-up threshold of the engine at the location being less than a first threshold difference, pressurizing a driveline disconnect clutch (DCC) to a touch point of the DCC to reduce a delay in starting the engine.

2. The method of claim 1, further comprising:
in response to the difference being greater than a second threshold difference, the second threshold difference greater than the first threshold difference, setting the DCC to an open state to reduce clutch drag and increase fuel efficiency.

3. The method of claim 2, further comprising:
in response to the difference being greater than the first threshold difference and less than the second threshold difference, pressurizing the DCC to less than the touch point.

4. The method of claim 1, wherein estimating the modified driver demand power at the location further comprises calculating a baseline driver demand power of the hybrid vehicle as a function of vehicle weight, based on at least one of:
historical driving data of the hybrid vehicle;
a driving profile of a driver of the hybrid vehicle; and
a time of day at which the hybrid vehicle is being operated.

5. The method of claim 4, further comprising calculating the baseline driver demand power of a vehicle as a function of vehicle weight based on at least one of:
historical data of other vehicles; and
crowdsourced data of other vehicles currently being operated along a route of the vehicle.

6. The method of claim 5, wherein estimating the modified driver demand power at the location further comprises calculating a first multiplication factor to apply to the baseline driver demand power at the location, based on a vehicle density of traffic at the location on the route, the vehicle density calculated based on at least one of:
a vehicle-to-vehicle (V2V) communication with a different vehicle on a route of the vehicle;
a vehicle-to-infrastructure (V2I) communication with an element of infrastructure located along the route; and
an exterior sensor of the vehicle.

7. The method of claim 6, wherein estimating the modified driver demand power at the location further comprises determining a second multiplication factor to apply to the baseline driver demand power at the location, based on electronic horizon data and route data.

8. The method of claim 7, wherein determining the second multiplication factor based on the electronic horizon data and the route data further comprises:
identifying a characteristic or feature of the route that is likely to cause an increase or decrease in the baseline driver demand power at the location; and
retrieving the second multiplication factor from a lookup table stored in a memory of the vehicle based on the identified characteristic or feature.

9. The method of claim 8, wherein the identified characteristic or feature is one of:
a traffic light;
a stop sign;
an on-ramp to a highway; and
a hill.

10. The method of claim 7, wherein estimating the modified driver demand power at the location further comprises creating a driver demand torque/power map based on the baseline driver demand power, the first multiplication factor, and the second multiplication factor, and estimating the modified driver demand power based on the driver demand torque/power map.

11. A system of a hybrid vehicle, comprising:
a modular hybrid transmission (MHT) including a disconnect clutch (DCC) that connects an electric machine and an engine of the hybrid vehicle to a driveline of the hybrid vehicle;
a controller, and instructions stored in a memory of the hybrid vehicle that when executed, cause the controller to:
when operating the hybrid vehicle with the engine off, estimate a modified driver demand power at a location on a route of the hybrid vehicle; and
prior to reaching the location, adjust the DCC to either maximize a fuel efficiency of the hybrid vehicle or reduce a delay in achieving the modified driver demand power using the engine, based on the modified driver demand power.

12. The system of claim 11, wherein further instructions are stored in the memory that when executed, cause the controller to:
calculate a difference between the modified driver demand power and an engine pull-up threshold of the hybrid vehicle;
in response to the difference being less than a first threshold difference, pressurize the DCC to a touch point of the DCC to reduce the delay in achieving the modified driver demand power;
in response to the difference being greater than a second threshold difference, adjust the DCC to an open, fully-depressurized state to maximize the fuel efficiency of the hybrid vehicle; and
in response to the difference being between the first threshold difference and the second threshold difference, pressurize the DCC to less than the touch point.

13. The system of claim 11, wherein further instructions are stored in the memory that when executed, cause the controller to estimate the modified driver demand power at the location by applying one or more multiplication factors to a baseline driver demand power, the baseline driver demand power calculated based on a weight of the hybrid vehicle and historical vehicle driving data.

14. The system of claim 13, wherein the baseline driver demand power is calculated based partly on data of a plurality of vehicles, the data of the plurality of vehicles including historical driving data of the plurality of vehicles and crowdsourced data of vehicles currently operating on the route.

15. The system of claim 13, wherein the one or more multiplication factors include a first multiplication factor based on a vehicle density of traffic on the route, the vehicle density estimated using at least one of vehicle-to-vehicle (V2V) communication, vehicle-to-infrastructure (V2I) communication, and an exterior sensor of the hybrid vehicle.

16. The system of claim 13, wherein the one or more multiplication factors include a second multiplication factor based on a characteristic or feature of the route at the location that is likely to cause an increase or decrease in the baseline driver demand power, the second multiplication factor retrieved from a lookup table of the hybrid vehicle.

17. A method, comprising:
collecting driver demand power request data of one or more drivers of one or more hybrid vehicles during operation of the one or more hybrid vehicles on a route under engine-off conditions, the driver demand power request data including:
a location of a hybrid vehicle on the route;
a weight of the hybrid vehicle;
a feature or characteristic of the route at the location; and
a vehicle density of traffic at the location;
processing the collected driver demand power request data to generate:
a baseline driver demand power scaled by vehicle weight at a plurality of locations of the route;
a first set of multiplication factors to be selectively applied to the baseline driver demand power, based on the vehicle density;
a second set of multiplication factors to be selectively applied to the baseline driver demand power, based on features or characteristics of the route at a given location of the route; and
storing in a memory of each hybrid vehicle of the one or more hybrid vehicles, a baseline driver demand power for the vehicle, the first set of multiplication factors, and the second set of multiplication factors; and instructions that when executed by a controller of the vehicle, cause the controller to:
when operating the hybrid vehicle with the engine off, estimate a modified driver demand power at a location on the route based on the stored baseline driver demand power, the stored first set of multiplication factors, and the stored second set of multiplication factors, and
in response to a difference between the modified driver demand power and a pull-up threshold of an engine of the hybrid vehicle at the location being less than a first threshold difference, pressurize a driveline disconnect clutch (DCC) of the to a touch point of the DCC to reduce a delay in starting the engine, prior to reaching the location.

18. The method of claim 17, further comprising:
in response to the difference being greater than a second threshold difference, setting the DCC to an unpressurized state to reduce clutch drag of the DCC;
in response to the difference being between the first threshold difference and the second threshold difference, pressurizing the DCC to less than the touch point.

19. The method of claim 17, wherein the vehicle density of traffic at the location is determined using one or more of vehicle-to-vehicle (V2V) communication, vehicle-to-infrastructure (V2I) communication, and an exterior sensor of the hybrid vehicle.

20. The method of claim 17, wherein the feature or characteristic of the route at the location is determined from navigation system data of the hybrid vehicle.
